(19) United States
(12) Patent Application Publication
(10) Pub. No.: US 2026/0283404 A1
(43) Pub. Date: Sep. 24, 2026

(54) FRY BASKET

(71) Applicant: Andrew D. Bowman, Oneida, IL (US)

(72) Inventor: Andrew D. Bowman, Oneida, IL (US)

(21) Appl. No.: 19/576,159

(22) Filed: Mar. 24, 2026

Related U.S. Application Data
(60) Provisional application No. 63/776,595, filed on Mar. 24, 2025.

(51) Int. Cl. A47J 37/12; A23L 7/187

(52) U.S. Cl. CPC A47J 37/1295; A23L 7/187

(57) ABSTRACT

A fry basket is provided for cooking smaller foods and other foods in cooking oil. The fry basket includes at least one side wall and a bottom wall defining a receptacle for receiving food to be cooked. The at least one side wall and the bottom wall are made from metal material such as stainless steel. The at least one side wall and bottom wall are perforated to allow the cooking oil to flow into and out of the receptacle while maintaining the smaller foods within the receptacle prior to, during, and/or after cooking.

### CROSS-REFERENCE TO RELATED APPLICATION

The present application claims priority to U.S. Provisional Application Ser. No. 63/776,595 filed on Mar. 24, 2025, which is incorporated herein by reference.

### FIELD OF THE INVENTION

The present disclosure relates to fry baskets, and more particularly to fry baskets for cooking food in cooking oil.

### BACKGROUND

Cooking oil is utilized in the food industry as a means to efficiently and quickly cook a variety of foods. Deep frying food in a fry basket is widely used in the food industry in order to quickly cook large quantities of food and is therefore important to restaurants and other commercial cooking venues. Wire mesh fry baskets can be employed to contain the food in the deep fryer during the cooking process and provide for easy retrieval.

The type of cooking oil that is utilized in frying impacts both the cooking time and the end product that is fried. For example, cooking oils can affect the health, taste, and nutrition of food the foods being cooked depending on the characteristics of the cooking oil that is used. Cooking oils vary in heating properties, such as smoke point, which also impacts heat transference and required cooking time.

Cooking time efficiency is an important consideration for restaurants to minimize costs and depends on cooking time and cooking temperature. The cooking time and cooking temperature vary depending on the type of food that is being cooked. The cooking time efficiency is also impacted by the type of cooking oil that is used and the cooking temperature of the cooking oil. While higher cooking temperatures can decrease the cooking time, there are limits since it is undesirable to “flash cook” the food, which cooks the external part of the food while leaving the internal part undercooked unless the external part is overcooked. In addition, many restaurants maintain food that is to be served in a frozen condition to preserve integrity and freshness. These frozen foods can be pulled from the freezer and placed directly into the cooking oil for immediate cooking. Thus, there is a need for heat transference that allows cooking to occur quickly while also ensuring the interior of the food is cooked.

Deep frying with cooking oil has been found to work best on food that include higher carbohydrate content, such as breading and other coatings. As a result, carbohydrates are selected for use with current deep drying systems, which contributes to less healthy food choices. In addition, foods selected for deep frying are of sufficient size to be able to be contained within the wire mesh fry basket without passing through the openings to avoid spillage.

Existing cooking methods suffer from a number of drawbacks and shortcomings including those respecting the ability to utilize healthier food options prepared in conjunction with deep frying. There remains a significant unmet need for the fry basket disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created and that the invention includes and protects such alterations, modifications, and further applications of the example embodiments as would occur to one skilled in the art.

### SUMMARY

Embodiments include a unique fry basket configuration able to cook smaller foods in a deep fryer such as popcorn. The fry basket includes a basket portion with at least one side wall and a bottom wall that define a receptacle for containing the food. The at least one side wall and bottom wall are made from a perforated material, such as a perforated metal material. The perforations allow the cooking oil to flow into and out of the receptacle while maintaining the smaller foods within the receptacle prior to, during, and/or after cooking. Further embodiments, forms, objects, features, advantages, aspects, and benefits shall become apparent from the following description and drawings.

### BRIEF DESCRIPTION OF THE FIGURES

FIG. 1 is a perspective view of a fry basket according to an embodiment of the present disclosure.

FIG. 2 is a top view of the fry basket of FIG. 1.

FIG. 3 is a side elevation view of the fry basket of FIG. 1.

FIG. 4 is an elevation view of a first end of the fry basket of FIG. 1.

FIG. 5 is an elevation view of a second end of the fry basket of FIG. 1.

### DETAILED DESCRIPTION OF EXAMPLE EMBODIMENTS

Embodiments of the present application include a fry basket that enables cooking of smaller foods in deep fryers while maintaining or increasing heat transference over wire mesh type fry baskets. Fry baskets according to the present disclosure incorporate perforated material that retains the smaller food within the receptacle of the fry basket while allowing cooking oil to flow into and out of the receptacle but can be employed with any type of food to be deep fried. The perforated material can be metal or other material that provides structural integrity and heat transference. In addition, the surface of the perforated material that extends around the receptacle provided by the fry basket of the present disclosure reduces abrasiveness and improves cleanability over that provided wire mesh baskets.

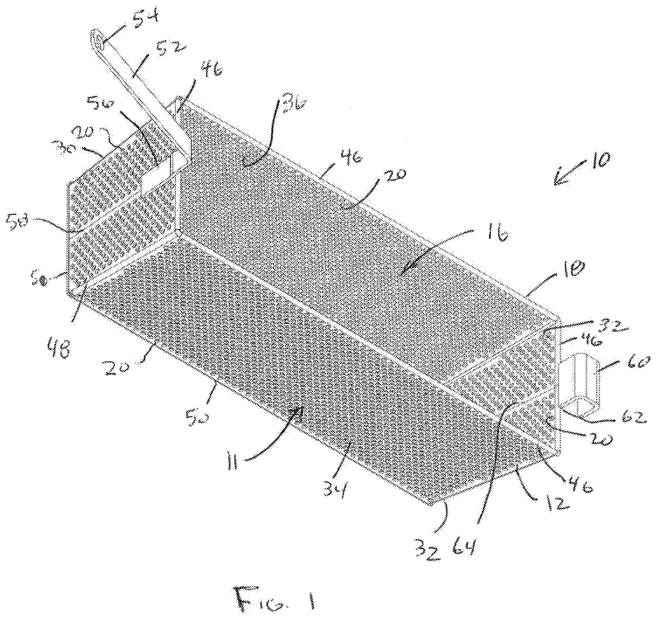

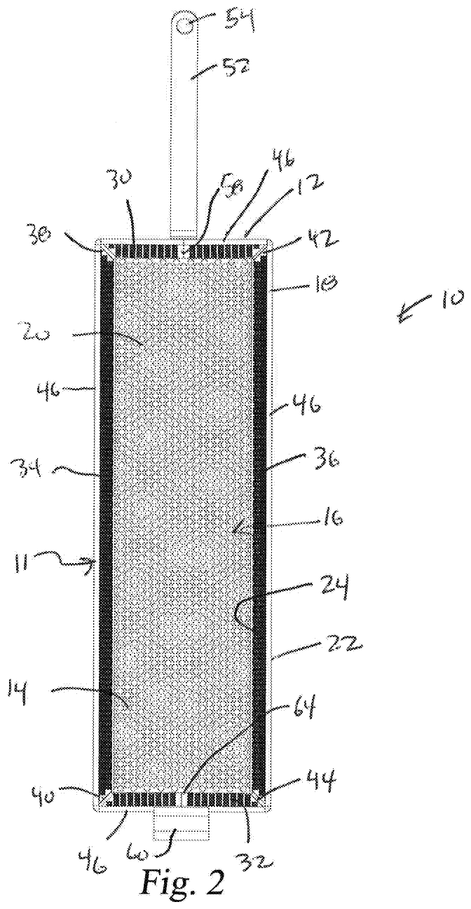

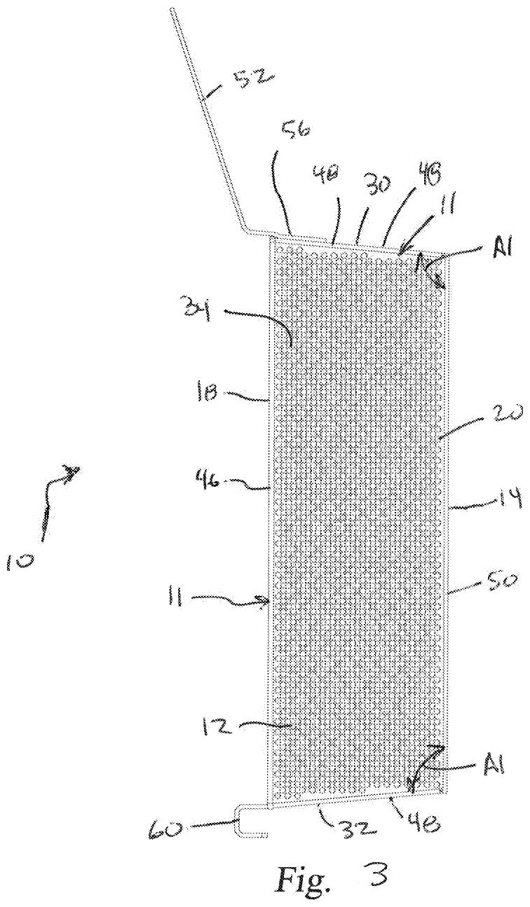

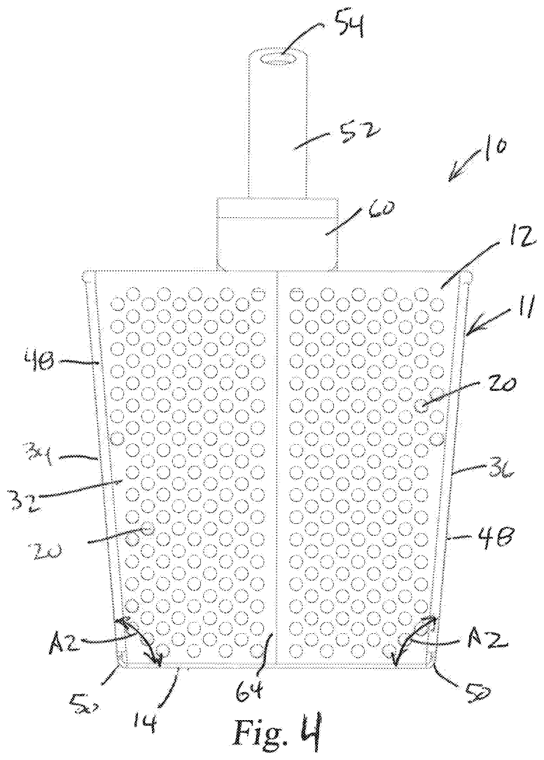

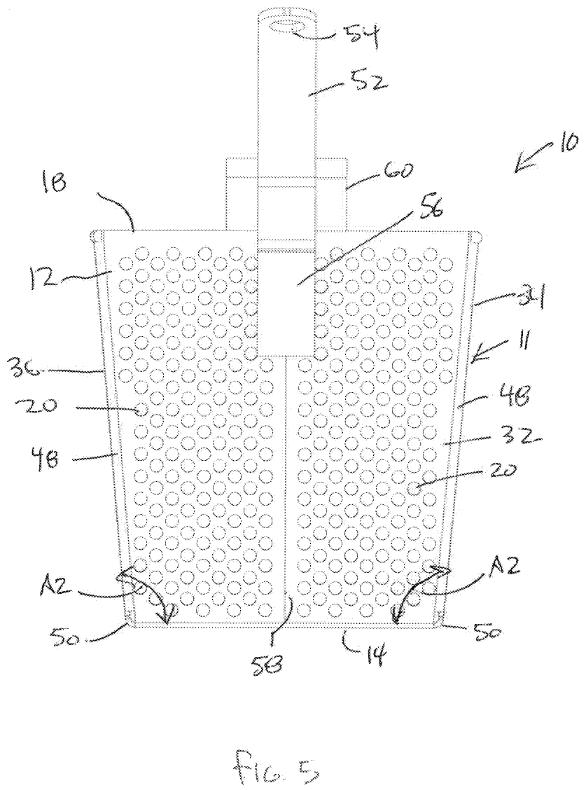

FIGS. 1-5 illustrate an embodiment of fry basket 10 according to an embodiment of the present disclosure. Fry basket 10 is shown that includes a basket portion 11. Basket portion 11 includes at least one side wall 12 and a bottom wall 14 that together define a receptacle 16. Food to be cooked in cooking oil, such as in a deep fryer, is placed into receptacle 16 through an open side 18 of basket portion 11 that is opposite bottom wall 14 and defined by the at least one side wall 12.

The at least one side wall 12 and bottom wall 14 are formed by plates of metal material that include a plurality of perforations 20. Perforations 20 extend through the plates of side wall 12 and bottom wall 14 from an exterior side 22 to an interior side 24. Interior side 24 extends around receptacle 16. The plates forming interior side 14 include a smooth surface profile against which the food in receptacle 16 is positioned. By using plate-like structures for the at least one side wall 12 and bottom wall 14 rather than wire mesh, the surface area of the cooking surface is reduced, which reduces the abrasiveness of fry basket 10 on the food. This improves cooking outcomes and allows smaller, more delicate foods to be successfully cooked in fry basket 10.

In an embodiment, some or all of the basket portion 11 is made from metal material in the form of perforated plates. In an embodiment, the metal material is stainless steel. In a specific embodiment, the metal material is 304 stainless steel. Other embodiments contemplate other suitable food grade perforated material for basket portion 11.

Perforations 20 through the plates of the at least one side wall 12 and bottom wall 14 allow cooking oil to ingress into receptacle 16 and egress out of receptacle 16 during and after the cooking process. Perforations 20 are sized so that small food placed into receptacle 16 does not pass from receptacle 16 through the perforations of the at least one side wall 12 and bottom wall 14, preventing spoilage and allowing deep frying of foods not heretofore conventionally cooked in a fry basket.

In an embodiment, the food placed into receptacle 16 is un-popped popcorn kernels. The kernels contained within receptacle 16 of fry basket 10 are cooked in cooking oil to expand in receptacle 16. The perforations 20 are sized and configured to prevent the kernels and popped popcorn from passing therethrough before, during, and after the cooking process. Other embodiments contemplate other types of small food may be cooked in fry basket 10. In addition, fry basket 10 may be employed with and reduce spoilage of larger foods that are traditionally cooked in a wire mesh type fry basket, such as french fries, curds, onion rings, and other foods.

The plurality of perforations 20 are provided at a density sufficient for heat transference and cooking oil flow into and out of receptacle 16. In an embodiment, the density of perforations 20 is such that at least 60% of the surface area of the at least one side wall 12 and bottom wall 14 is occupied by perforations 20. In another embodiment, at least 65% of the surface area of the at least one side wall 12 and bottom wall 14 is occupied by perforations 20. In an embodiment, the at least one side wall 12 and/or bottom wall 14 provide a ratio of area defined by openings formed by perforations through the at least one side wall 12 and/or bottom wall 14 to a total area of the least one side wall 12 and/or bottom wall 14 that is at least 60%. In another embodiment, the ratio is at least 65%.

The material from which at least one side wall 12 and bottom wall 14 are fabricated are of sufficient thickness to provide basket portion 11 with structural integrity and stability after formation of perforations 20 at a relatively high density. Perforations 20 can be formed by drilling, punching, cutting, lasering, or otherwise creating the desired shape, size, and number of openings or holes that extend through at least one side wall 12 and bottom wall 14. In an embodiment, the at least one side wall 12 and/or bottom wall 14 are made from metal plates, and the thickness of the metal plates exceeds 18 gauge. In an embodiment, metal plates of 16 gauge thickness are used. Other thicknesses for the metal plates are also contemplated, such as 12 gauge.

The perforations 20 in the illustrated embodiment are generally circular in shape. Other embodiments contemplate other shapes for perforations 20, including non-circular shapes such as triangular shapes, square shapes, ovoid shapes, polygonal shapes, etc. In an embodiment, the opening formed by each of perforations 20 has a maximum dimension that is no larger than 5/32 of an inch (0.156 inches), which is suitable to retain un-popped popcorn kernels. Other embodiments contemplate other maximum dimensions for perforations 20.

In an embodiment, the at least one side wall 12 includes a plurality of side walls formed by plates that are connected to one another and to bottom wall 14 to form a rectangular-shaped receptacle 16. In another embodiment, the at least one side wall 12 is formed by a singular plate that is bent or otherwise shaped to form receptacle 16 around bottom wall 14 in a circular shape, ovoid shape, or other suitable shape.

In the illustrated embodiment, at least one side wall 12 includes a first end wall 30 connected to and extending upwardly from a first end of bottom wall 14 and a second end wall 32 connected to and extending upwardly from a second end of bottom wall 14 opposite the first end wall 30. At least one side wall 12 also includes a first lateral wall 34 connected to and extending upwardly from a first lateral side of bottom wall 14 and a second lateral wall 36 connected to and extending upwardly from a second lateral side of bottom wall 14. The first and second ends of lateral walls 34, 36 are connected to respective first and second sides of each of the end wall 30, 32 to form corners 38, 40, 42, 44.

In an embodiment, end walls 30, 32 and lateral walls 34, 36 are connected to bottom wall 14 and to each other at corners 38, 40, 42, 44. In an embodiment, the connection is formed by welding, fusing, fastening, or otherwise connecting adjacent edges of the plates forming walls 30, 32, 34, 36 together.

In an embodiment, basket portion 11 includes trim pieces to eliminate any sharp edges formed by the connections of walls 14, 30, 32, 34 36. For example, rounded, convex trim pieces 46 can be provided along upper edges of end walls 30, 32 and lateral walls 34, 36 that form open side 18 into receptacle 16. Rounded, convex trim pieces 48 may also be provided along the exterior sides of corners 38, 40, 42, 44 and rounded, convex trim pieces 50 may be provide along the exterior sides of the connections of end and lateral walls 30, 32, 34, 36 with bottom wall 14.

End walls 30, 32 and lateral walls 34, 36 diverge away from one another as they extend upwardly from bottom wall 14 to open side 18. This causes receptacle 14 to widen and volumetrically increase away from bottom wall 14 to provide a maximum size at open side 18. In an embodiment, obtuse angles A1 are formed by end walls 30, 32 with bottom wall 14, and obtuse angles A2 are formed by lateral walls 34, 36 with bottom wall 14. In an embodiment, obtuse angles A1, A2 are more than about 95 degrees. In a specific embodiment, angle A1 is 95.4 degrees and angle A2 is about 95.1 degrees, but other angular values are also contemplated.

Fry basket 10 can also include a handle 52 attached to first end wall 30. Handle 52 can be L-shaped and include a hole 54 to facilitate hanging of fry basket 10. Handle 52 also includes an attachment tab 56 attached to first end wall 30 such as by welding and/or fasteners. In an embodiment, first end wall 30 includes a non-perforated strip 58 extending from open side 18 to bottom wall 14 to provide rigidity for basket portion 11 at the attachment location of handle 52 where lifting forces are concentrated.

Fry basket 10 can also include a hook 60 attached to second end wall 32. Hook 60 can be U-shaped to facilitate hanging of fry basket 10 on the deep fryer above the cooking oil or other location. Hook 60 includes an attachment tab 62 attached to second end wall 32 such as by welding and/or fasteners. In an embodiment, second end wall 32 includes a non-perforated strip 64 extending from open side 18 to bottom wall 14 to provide rigidity for basket portion 11 at the attachment location of hook 60 where hanging forces are concentrated.

A number of embodiments of the present disclosure are contemplated. For example, one embodiment is a fry basket that includes a basket portion including at least one side wall and a bottom wall. The at least one side wall and the bottom wall define a receptacle for containing food to be cooked in cooking oil. The at least one side wall and the bottom wall are made from a metal material that is perforated to allow cooking oil to flow into and out of the receptacle while the food is contained within the receptacle before, during, and after cooking.

In an embodiment, the food is popcorn kernels that are popped in the receptacle with the cooking oil.

In an embodiment, the perforations are circular.

In an embodiment, at least some of the perforations are non-circular.

In an embodiment, the perforations each form a maximum opening dimension through the at least one side wall. The maximum opening dimension being less than or equal to 0.156 inches.

In an embodiment, a density of the perforations through the at least one side wall provides a ratio of opening area through the at least one side wall to a total area through the least one side wall that is at least 60%.

In an embodiment, the at least one side wall includes a first end wall attached to the bottom wall and a second end wall opposite the first end wall, the second end wall attached to the bottom wall. The at least one side wall also includes a first lateral wall extending from the first end wall to the second end wall and a second lateral wall spaced from the first lateral wall extending from the first end wall to the second end wall. The first lateral wall and the second lateral wall are attached to the bottom wall.

In an embodiment, each of the bottom wall, the first end wall, the second end wall, the first lateral wall, and the second lateral wall includes a plurality of perforations extending therethrough.

In an embodiment, each of the bottom wall, the first end wall, the second end wall, the first lateral wall, and the second lateral wall is in the form of a plate of metal material that is stainless steel.

In an embodiment, each of the stainless steel plates has a thickness that is greater than 18 gauge.

In an embodiment, the stainless steel plates provide a smooth surface around the receptacle.

In an embodiment, each of the first end wall, the second end wall, the first lateral wall, and the second lateral wall extend upwardly from the bottom wall at an angle of greater than 90 degrees so that the receptacle widens in a direction away from the bottom wall.

In an embodiment, the angle is more than 95 degrees.

In an embodiment, the first end wall, the second end wall, the first lateral wall, and the second lateral wall define an open side into the receptacle opposite the bottom wall. The basket portion includes a rounded trim on edges of the first end wall, the second end wall, the first lateral wall, and the second lateral wall around the open side.

In an embodiment, the basket portion includes rounded trim along each corner formed by junctions of the first and second end walls with the first and second lateral walls.

In an embodiment, the basket portion includes rounded trim along each of junction of the first and second end walls and the first and second lateral walls with the bottom wall.

In an embodiment, the at least one side wall includes a first end wall. The fry basket includes a handle portion attached to the first end wall.

In an embodiment, the at least one side wall includes a second end wall opposite the first end wall. The fry basket includes a hook portion attached to the second end wall.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A fry basket, the fry basket comprising:
a basket portion including at least one side wall and a bottom wall, the at least one side wall and the bottom wall defining a receptacle for containing food to be cooked in cooking oil, the at least one side wall and the bottom wall being made from a metal material that is perforated to allow cooking oil to flow into and out of the receptacle while the food is contained within the receptacle before, during, and after cooking.

2. The fry basket of claim 1, wherein the food is popcorn kernels that are popped in the receptacle with the cooking oil.

3. The fry basket of claim 1, wherein the perforations are circular.

4. The fry basket of claim 1, wherein at least some of the perforations are non-circular.

5. The fry basket of claim 1, wherein the perforations each form a maximum opening dimension through the at least one side wall, the maximum opening dimension being less than or equal to 0.156 inches.

6. The fry basket of claim 1, wherein a density of the perforations through the at least one side wall provides a ratio of opening area through the at least one side wall to a total area through the least one side wall that is at least 60%.

7. The fry basket of claim 1, wherein the at least one side wall includes:
a first end wall attached to the bottom wall;
a second end wall opposite the first end wall, the second end wall attached to the bottom wall;
a first lateral wall extending from the first end wall to the second end wall, the first lateral wall attached to the bottom wall; and
a second lateral wall spaced from the first lateral wall that extends from the first end wall to the second end wall, the second lateral wall attached to the bottom wall.

8. The fry basket of claim 7, wherein each of the bottom wall, the first end wall, the second end wall, the first lateral wall, and the second lateral wall includes a plurality of perforations extending therethrough.

9. The fry basket of claim 8, wherein each of the bottom wall, the first end wall, the second end wall, the first lateral wall, and the second lateral wall is in the form of a plate of metal material that is stainless steel.

10. The fry basket of claim 9, wherein each of the stainless steel plates has a thickness that is greater than 18 gauge.

11. The fry basket of claim 9, wherein the stainless steel plates provide a smooth surface around the receptacle.

12. The fry basket of claim 7, wherein each of the first end wall, the second end wall, the first lateral wall, and the second lateral wall extend upwardly from the bottom wall at an angle of greater than 90 degrees so that the receptacle widens in a direction away from the bottom wall.

13. The fry basket of claim 12, wherein the angle is more than 95 degrees.

14. The fry basket of claim 7, wherein the first end wall, the second end wall, the first lateral wall, and the second lateral wall define an open side into the receptacle opposite the bottom wall, and further comprising a rounded trim on edges of the first end wall, the second end wall, the first lateral wall, and the second lateral wall around the open side.

15. The fry basket of claim 14, wherein the basket portion includes rounded trim along each corner formed by junctions of the first and second end walls with the first and second lateral walls.

16. The fry basket of claim 14, wherein the basket portion includes rounded trim along each of junction of the first and second end walls and the first and second lateral walls with the bottom wall.

17. The fry basket of claim 1, wherein the at least one side wall includes a first end wall, and further comprising a handle portion attached to the first end wall.

18. The fry basket of claim 17, wherein the at least one side wall includes a second end wall opposite the first end wall, and further comprising a hook portion attached to the second end wall.
